(19) United States
(12) Patent Application Publication
(10) Pub. No.: US 2025/0388220 A1
(43) Pub. Date: Dec. 25, 2025

(54) VEHICLE AND METHOD OF CONTROLLING THE SAME USING ESTIMATED WEIGHT

(71) Applicants: Hyundai Motor Company, Seoul (KR); Kia Corporation, Seoul (KR)

(72) Inventor: Young Kwang Kim, Hwaseong-si (KR)

(21) Appl. No.: 18/953,649

(22) Filed: Nov. 20, 2024

(30) Foreign Application Priority Data
Jun. 25, 2024 (KR) 10-2024-0082895

(51) Int. Cl. B60W 40/13; B60W 30/02

(52) U.S. Cl. CPC B60W 40/13; B60W 30/02

(57) ABSTRACT

A method for estimating the weight of and controlling a vehicle may include determining, based on a first weight estimation being applied to vehicle data, first estimated weight information of the vehicle. The first weight estimation may be based on recursive least squares (RLS) associated with a first forgetting factor. The method may further include determining, based on a second weight estimation being applied to the vehicle data, second estimated weight information of the vehicle. The second weight estimation may be based on RLS associated with a second forgetting factor. The method may further include determining, based on the first and second estimated weight information, a third forgetting factor for RLS of a third weight estimation; determining, based on the third weight estimation being applied to the vehicle data, third estimated weight information of the vehicle; and controlling, based on the third estimated weight information, the vehicle.

### CROSS REFERENCE TO RELATED APPLICATION

The present application claims priority to a Korean provisional application No. 10-2024-0082895, filed Jun. 25, 2024, the entire contents of which are incorporated herein for all purposes.

### TECHNICAL FIELD

The present disclosure relates to a method and a vehicle for estimating a weight based on multiple RLSs with a forgetting factor, and more particularly, to a weight estimation method and a vehicle that enable a weight estimation in the vehicle to quickly converge and an accurate estimated weight to be obtained, thereby maximizing stability of vehicle control.

### BACKGROUND

Weight estimation includes calculations of complex factors during driving such as vehicle speed, motor torque feedback, powertrain efficiency and driving resistance, and powertrain efficiency and other factors are difficult to accurately model. In such a situation, for stable weight estimation, a forgetting factor of Recursive Least Square (RLS) is set to be close to 1. Thus, accuracy needs to be improved so that many measurements can be utilized for weight estimation.

However, in the case of a large commercial car, where the difference between an empty vehicle weight and a loaded vehicle weight has a wide range, for example, from 14 tons to 36 tons, which is more than doubled, it may take a long time for an initial assumed value usually based on a median value like 25 tons to converge on an actual weight. For example, it takes more than 10 minutes for the initial assumed value of 25 tons to converge on an actual weight of 14 tons. Accordingly, when a weight-adapted torque and regenerative braking control are applied, a sense of displacement may occur to vehicle control during an initial convergence time, and it becomes a factor that degrades the quality of a vehicle.

In addition, an observed value of an accelerometer is used as a default input for weight estimation, but if a sensor or a controller is replaced as a single item, no offset correction may be performed. In such a situation, as RLS weight estimation diverges, vehicle control abnormality caused by weight estimation error in the situation needs to be prevented.

### SUMMARY

The present disclosure is technically directed to providing a method and a vehicle for estimating a weight based on multiple RLSs with a forgetting factor, which enable a weight estimation in the vehicle to quickly converge and an accurate estimated weight to be obtained, thereby maximizing stability of vehicle control.

The technical problems solved by the present disclosure are not limited to the above technical problems and other technical problems which are not described herein will be clearly understood by a person having ordinary skill in the technical field, to which the present disclosure belongs, from the following description.

According to one or more example embodiments of the present disclosure, a method performed by an apparatus of a vehicle may include: determining, based on a first weight estimation being applied to vehicle data, first estimated weight information of the vehicle. The first weight estimation may be based on recursive least squares (RLS) associated with a first forgetting factor. The method may further include determining, based on a second weight estimation being applied to the vehicle data, second estimated weight information of the vehicle. The second weight estimation may be based on RLS associated with a second forgetting factor. The method may further include determining, based on the first estimated weight information and the second estimated weight information, a third forgetting factor for RLS of a third weight estimation; determining, based on the third weight estimation being applied to the vehicle data, third estimated weight information of the vehicle; and controlling, based on the third estimated weight information, the vehicle.

The third forgetting factor may be differently determined based on a difference between the first estimated weight information and the second estimated weight information. The second forgetting factor may have a lower forgetting feature than the first forgetting factor.

The method may further include: determining whether there is an aggressive update request for the third weight estimation, based on at least one of an operation state of the vehicle, a weight estimation error state related to a divergence state of the first weight estimation, or a difference between the first estimated weight information and the second estimated weight information; and applying, based on the aggressive update request, an aggressive forgetting factor to the third forgetting factor. The aggressive forgetting factor may indicate a forgetting feature associated with an increased forgetting rate. Determining the third estimated weight information may include determining, by an aggressive update of the third weight estimation, the third estimated weight information based on the vehicle data.

The method may further include: determining whether there is an aggressive update request for the third weight estimation, based on at least one of an operation state of the vehicle, a weight estimation error state related to a divergence state of the first weight estimation, or a difference between the first estimated weight information and the second estimated weight information. Determining the third forgetting factor may include determining the third forgetting factor based on a determination that the aggressive update request is absent. A conservative forgetting factor may be applied to the third forgetting factor. The conservative forgetting factor may indicate a forgetting feature associated with a decreased forgetting rate.

The aggressive update of the third weight estimation may be performed a predetermined number of times. Determining the third estimated weight information may include determining the third estimated weight information after the aggressive update of the third weight estimation.

The operation state of the vehicle may include a state of transition from an OFF state to an ON state.

The weight estimation error state may include the first weight estimation being a divergence state. A standard deviation of the first estimated weight information may be greater than a deviation reference value based on an acceleration offset caused by a gradient, on which the vehicle is running, or a replaced component of the vehicle.

The method may further include correcting the acceleration offset before the determining of the third estimated weight information by the aggressive update of the third weight estimation. The aggressive update of the third weight estimation may be performed after the acceleration offset is corrected.

Determining whether there is the aggressive update request may include activating the aggressive update request, based on a successive difference between the first estimated weight information and the second estimated weight information being greater than a threshold difference. The successive difference may be determined in time series.

The method may further include performing an update of the first weight estimation and the second weight estimation while the aggressive update of the third weight estimation is being performed.

According to one or more example embodiments of the present disclosure, a vehicle may include: memory storing at least one instruction for controlling the vehicle; and a processor configured to execute the at least one instruction stored in the memory. The at least one instruction may be configured to cause, when executed by the processor, the vehicle to: determine, based on a first weight estimation being applied to vehicle data, first estimated weight information of the vehicle. The first weight estimation may be based on recursive least squares (RLS) associated with a first forgetting factor. The at least one instruction may be further configured to cause, when executed by the processor, the vehicle to determine, based on a second weight estimation being applied to the vehicle data, second estimated weight information of the vehicle. The second weight estimation may be based on RLS associated with a second forgetting factor. The at least one instruction may be further configured to cause, when executed by the processor, the vehicle to determine, based on the first estimated weight information and the second estimated weight information, a third forgetting factor for RLS of a third weight estimation; determine, based on the third weight estimation being applied to the vehicle data, third estimated weight information of the vehicle; and control, based on the third estimated weight information, the vehicle.

The third forgetting factor may be differently determined based on a difference between the first estimated weight information and the second estimated weight information. The second forgetting factor may have a lower forgetting feature than the first forgetting factor.

The at least one instruction may be configured to cause, when executed by the processor, the vehicle to: determine whether there is an aggressive update request for the third weight estimation, based on at least one of an operation state of the vehicle, a weight estimation error state related to a divergence state of the first weight estimation, or a difference between the first estimated weight information and the second estimated weight information, and apply, based on the aggressive update request, an aggressive forgetting factor to the third forgetting factor. The aggressive forgetting factor may indicate a forgetting feature associated with an increased forgetting rate, and determine the third estimated weight information by determining, by an aggressive update of the third weight estimation, the third estimated weight information based on the vehicle data.

The at least one instruction may be configured to cause, when executed by the processor, the vehicle to: determine whether there is an aggressive update request for the third weight estimation, based on at least one of an operation state of the vehicle, a weight estimation error state related to a divergence state of the first weight estimation, or a difference between the first estimated weight information and the second estimated weight information; and determine the third forgetting factor by determining the third forgetting factor based on a determination that the aggressive update request is absent. A conservative forgetting factor may be applied to the third forgetting factor. The conservative forgetting factor may indicate a forgetting feature associated with a decreased forgetting rate.

The aggressive update of the third weight estimation may be performed a predetermined number of times. The at least one instruction may be configured to cause, when executed by the processor, the vehicle to determine the third estimated weight information by determining the third estimated weight information, after the aggressive update of the third weight estimation.

The operation state of the vehicle may include a state of transition from an OFF state to an ON state.

The weight estimation error state may include the first weight estimation being a divergent state. A standard deviation of the first estimated weight information may be greater than a deviation reference value based on an acceleration offset caused by a gradient, on which the vehicle is running, or a replaced component of the vehicle.

The at least one instruction may be configured to cause, when executed by the processor, the vehicle to correct the acceleration offset before determining the third estimated weight information by the aggressive update of the third weight estimation. The aggressive update of the third weight estimation may be performed after the acceleration offset is corrected.

The at least one instruction may be configured to cause, when executed by the processor, the vehicle to activate the aggressive update request, based on a successive difference between the first estimated weight information and the second estimated weight information being greater than a threshold difference. The successive difference may be determined in time series.

The at least one instruction may be configured to cause, when executed by the processor, the vehicle to perform an update of the first weight estimation and the second weight estimation while the aggressive update of the third weight estimation is being performed.

The vehicle may be configured to perform one or more operations and/or methods described herein.

The features of the present disclosure, which are briefly summarized herein, are only examples of aspects of features of the present disclosure and detailed description of the disclosure which follows and are not intended to limit the scope of the present disclosure.

The technical problems solved by the present disclosure are not limited to the above-mentioned technical problems. Other technical problems solved by the present disclosure, which are not described herein should be more clearly understood by a person having ordinary skill in the art of technical field to which the present disclosure belongs, from the following description.

According to present disclosure, it is possible to provide a method and a vehicle for estimating a weight based on multiple RLSs with a forgetting factor, which enable a weight estimation in the vehicle to quickly converge and an accurate estimated weight to be obtained, thereby maximizing stability of vehicle control.

The effects obtainable from the present disclosure are not limited to the above-mentioned effects, and other effects not mentioned herein will be clearly understood by those skilled in the art through the following descriptions.

### BRIEF DESCRIPTION OF THE DRAWINGS

FIG. 1 show an example of a vehicle communicating with another device to transmit and receive data.

FIG. 2 show an example of constituent modules of a vehicle according to an embodiment of the present disclosure.

FIG. 3 is a block diagram of a system that implements weight estimation in a vehicle according to an embodiment of the present disclosure.

FIG. 4 show an example of functional modules of a weight estimator.

FIG. 5 show an example of RLS logic that is applied to a weight estimator.

FIG. 6 is a flowchart of a method for estimating a weight according to another embodiment of the present disclosure.

FIG. 7 show an example of logic that is processed in a multi-RLS supervisor.

FIG. 8 is a flowchart of a process performed in a vehicle state determination logic.

FIG. 9 is a flowchart of a process of determining weight estimation error, which is performed in a convergence state determination logic.

FIG. 10 is a flowchart of a process related to an aggressive update request of convergence state determination logic.

FIG. 11 is a flowchart of a process that is performed in determination logic of a forgetting factor.

FIG. 12 show an example of data of a result to which a weight estimation method according to the present disclosure is applied.

FIG. 13 show an example of other data of a result to which a weight estimation method according to the present disclosure is applied.

### DETAILED DESCRIPTION

Herein after, examples of the present disclosure are described in detail with reference to the accompanying drawings so that those having ordinary skill in the art may easily implement the present disclosure. However, examples of the present disclosure may be implemented in various different ways and thus the present disclosure is not limited to the examples described therein.

In describing examples of the present disclosure, well-known functions or constructions have not been described in detail since a detailed description thereof may have unnecessarily obscured the gist of the present disclosure. The same constituent elements in the drawings are denoted by the same reference numerals and a repeated or duplicative description of the same elements has been omitted.

In the present disclosure, when an element is simply referred to as being “connected to”, “coupled to” or “linked to” another element, this may mean that an element is “directly connected to”, “directly coupled to”, or “directly linked to” another element or this may mean that an element is connected to, coupled to, or linked to another element with another element intervening therebetween. In addition, when an element “includes” or “has” another element, this means that one element may further include another element without excluding another component unless specifically stated otherwise.

In the present disclosure, the terms first, second, etc. are only used to distinguish one element from another and do not limit the order or the degree of importance between the elements unless specifically stated otherwise. Accordingly, a first element in an example may be termed a second element in another example, and, similarly, a second element in an example could be termed a first element in another example, without departing from the scope of the present disclosure.

In the present disclosure, elements are distinguished from each other for clearly describing each feature, but this does not necessarily mean that the elements are separated. In other words, a plurality of elements may be integrated in one hardware or software unit, or one element may be distributed and formed in a plurality of hardware or software units. Therefore, even if not mentioned otherwise, such integrated or distributed examples are included in the scope of the present disclosure.

In the present disclosure, elements described in various examples do not necessarily mean essential elements, and some of them may be optional elements. Therefore, an example composed of a subset of elements described in an example is also included in the scope of the present disclosure. In addition, examples including other elements in addition to the elements described in the various examples are also included in the scope of the present disclosure.

The advantages and features of the present disclosure and the ways of attaining them should become apparent to those of ordinary skill in the art with reference to examples of the present disclosure described below in detail in conjunction with the accompanying drawings. The examples of the present disclosure, however, may be embodied in many different forms and should not be constructed as being limited to the example examples set forth herein. Rather, the examples described herein are provided to make this disclosure more complete and to fully convey the scope of the present disclosure to those having ordinary skill in the art to which the present disclosure pertains.

In the present disclosure, each of phrases such as “A or B”, “at least one of A and B”, “at least one of A or B”, “A, B or C”, “at least one of A, B and C”, and each of the phrases such as “at least one of A, B or C” and “at least one of A, B, C or combination thereof” may include any one or all possible combinations of the items listed together in the corresponding one of the phrases.

In the present disclosure, expressions of location relations used in the present specification such as “upper”, “lower”, “left” and “right” are employed for the convenience of explanation, and when drawings illustrated in the present specification are inversed, the location relations described in the specification may be inversely understood. When a component, device, element, or the like of the present disclosure is described as having a purpose or performing an operation, function, or the like, the component, device, or element should be considered herein as being “configured to” meet that purpose or perform that operation or function.

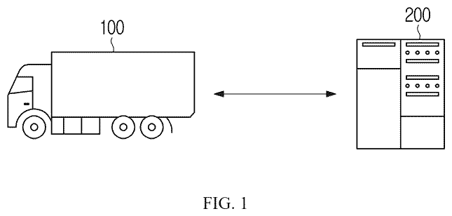

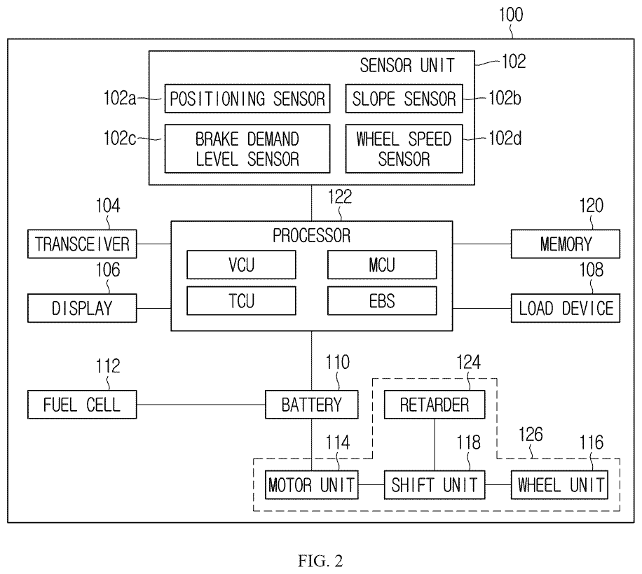

Hereinafter, with reference to FIG. 1 and FIG. 2, a vehicle implementing driving control using adaptive regenerative braking according to an embodiment of the present disclosure will be described. FIG. 1 is a view exemplifying a vehicle communicating with another device to transmit and receive data.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein. One or more features associated with autonomous driving control may be activated based on configured autonomous driving control setting(s) (e.g., based on at least one of: an autonomous driving classification, a selection of an autonomous driving level for a vehicle, etc.).

Based on one or more features (e.g., weight estimation features) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., weight estimation features) described herein. One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., weight estimation features) described herein.

Minimum risk maneuver (MRM) operation(s) may also be controlled, for example, based on one or more features (e.g., weight estimation features) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., weight estimation features) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane.

The driving control apparatus may identify a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., weight estimation features) described herein.

An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.)

Referring to FIG. 1, a vehicle 100 may be driven based on electric energy. In the case of electric energy, for example, the vehicle 100 may be a pure battery-based vehicle driven only by a high-voltage battery or employ a gas-based fuel cell as an energy source. In the case of a fuel cell, the vehicle 100 may charge a high-voltage battery by power generation of the fuel cell and execute various functions required by the modules of the vehicle 100 by output power of the high-voltage battery. In addition, the fuel cell may use various types of gas capable of generating electric energy, and for example, the gas may be hydrogen. However, without being limited thereto, various gases are applicable.

For convenience of explanation, the present disclosure describes an example in which an electric energy vehicle is the fuel cell-based vehicle 100. However, the present disclosure is applicable to a vehicle where a high-voltage battery and a cell are of different types and which employs a method of charging the high-voltage battery by power generation of the cell to output power for the start-up and drive of the vehicle 100 and a load device 120. In addition, the present disclosure may also be applied to a vehicle that is driven only by an electric battery.

The vehicle 100 may refer to a device capable of moving. The vehicle 100 is a vehicle as a ground vehicle driven on the ground and may be a normal passenger vehicle or commercial vehicle, a mobile office, or a mobile hotel. The vehicle 100 may be a four-wheel vehicle, for example, a sedan, a sports utility vehicle (SUV), and a pickup truck and may also be a vehicle with five or more wheels, for example, a bus, a lorry, a container truck, and a heavy vehicle. The vehicle 100 may be implemented by manual driving or autonomous driving (either semi-autonomous or full-autonomous driving).

Meanwhile, the vehicle 100 may perform communication with another device 200 or another vehicle under the control of a communication control unit (CTU) mounted in the vehicle 100. For example, another device may include a server 200 for supporting various control, state management and driving of the vehicle 100, an ITS device for receiving information from an intelligent transportation system (ITS), and various types of user devices.

The vehicle 100 may communicate with another vehicle or another device based on cellular communication, wireless access in vehicular environment (WAVE) communication, dedicated short range communication (DSRC) or short-range communication, or any other communication scheme.

For example, the vehicle 100 may use LTE as a cellular communication network, a communication network such as 5G, a WiFi communication network, a WAVE communication network, and the like to communicate with the server 200 and another vehicle. As another example, DSRC used in the vehicle 100 may be used for vehicle-to-vehicle communication. A communication scheme among the vehicle 100, the server 200, another vehicle, and a user device is not limited to the above-described embodiment.

In order to support autonomous driving and various services for the vehicle 100, the server 200 may transmit various types of information and software modules used for controlling the vehicle 100 to the vehicle 100 as a response to a request and data transmitted from the vehicle 100 and a user device.

FIG. 2 is a view showing constituent modules of a vehicle according to an embodiment of the present disclosure.

The vehicle 100 may include a sensor unit 102, a transceiver 104, a display 106, and a load device 108.

The sensor unit 102 may be equipped with a detector for sensing various states, operations and situations that occur in the external environment and inside the vehicle 100. In addition, the sensor unit 102 may be equipped with various types of detectors that identify location information of the vehicle 100.

Specifically, the sensor unit 102 may include a positioning sensor 102a for obtaining location information of the vehicle 100, a slope sensor 102b, a brake demand level sensor 102c for detecting a brake demand level (brake position) and an acceleration demand level required by a user or the processor 122, and a wheel speed sensor 102d for measuring the speed of the vehicle 100.

The positioning sensor 102a may generate two-dimensional location data by measuring the latitude and longitude of the vehicle 100 or measure an altitude in addition to the two-dimensional location data.

For example, the slope sensor 102b may measure a stance of the vehicle 100 and a tilting angle of the vehicle 100 through a gyro sensor, an inertia sensor and the like. The processor 122 may calculate a gradient of a road, on which the vehicle 100 is running, or a gradient of the vehicle 100 based on a value measured from the slope sensor 102b.

The brake demand level sensor 102c may detect a demand level included in a user's braking request, and for example, sense a user's pedal maneuver amount through a brake pedal or the user's demand level through an acceleration interface. The brake demand level sensor 102d capable of measuring a user's pedal maneuver amount may be a brake point sensor (BPS).

The present disclosure mainly describes sensors of the sensor unit 102 described through an embodiment referred to herein but may further include a sensor for detecting various situations not listed herein such as a camera, a Lidar sensor and a radar sensor.

The transceiver 106 may support mutual communication with the server 200, the neighboring vehicle 300, and the like. In the present disclosure, the transceiver 106 may transmit data generated or stored during driving to the server 200 and receive data and a software module transmitted from the server 200. In the present disclosure, the vehicle 100 may transmit and receive data used in a method according to the present disclosure to and from the outside through the transceiver 106. In the present disclosure, the transceiver 106 may receive and forward map information and situation information to the memory 120 and the processor 122.

The display 108 may serve as a user interface. By the processor 122, the display 108 may display an operating state and a control state of the vehicle 100, route information according to navigation, traffic information around the vehicle 100, information on a remaining energy quantity, a content requested by a driver, and the like to be output. The display 108 may be configured as a touch screen capable of sensing a driver input and receive a request of a driver indicated to the processor 122.

The load device 108 may be an auxiliary equipment mounted on the vehicle 100, which consumes power supplied from the battery 110 by use of an occupant or a user. In the present disclosure, the load device 108 may be a type of electric device for non-driving purpose excluding a driving power system like the motor unit 110 for wheel drive. For example, the load device 108 may be an air-conditioning system, a light system, a seat system, and various devices installed in the vehicle 100.

The vehicle 100 may include the battery 110, a fuel cell 112, a motor unit 114, a shift unit 118, a retarder 124 and a wheel unit 116. In the present disclosure, the motor unit 114, the shift unit 118, the retarder 124 and the wheel unit 116 may constitute a power-train component 126.

The vehicle 100 is a mobility with a plurality of wheels, and all the wheels may be driven by being connected, for example, with the motor unit 114. In the present disclosure, for convenience of explanation, the motor unit 114, the shift unit 118, and the wheel unit 116 are illustrated as a single unit in FIG. 2. According to the number of wheels of the vehicle 100, the motor unit 114, the shift unit 118, and the wheel unit 116 increase according to the number, but because the motor unit 114, the shift unit 118, and the wheel unit 116, which drive each wheel, have an actually same function, these members may be understood to represent modules that drive each wheel. As another example, only some of the wheels may be coupled with the motor unit 114, and wheels not coupled with the motor unit 114 may be driven by a wheel driven from a motor.

The battery 110 and the fuel cell 112 may both supply power permanently, or the battery 110 and the fuel cell 112 may be used as a main power source and an auxiliary power source respectively.

The battery 110 may be a pure electric battery that is configured as a secondary cell charged by the fuel cell 112. In case regenerative braking is performed, the battery 110 may be charged by a counter electromotive force of the motor unit 114.

The fuel cell 112 may have a lower-voltage output than the battery 110 but may be configured to have a high energy density or a high charging capacity. As an example, the fuel cell 112 may be configured as a hydrogen-based fuel cell that generates electric energy through reaction between hydrogen gas filling a tank (not shown) from outside and oxygen flowing from a supplier (not shown).

The battery 110 may be charged by receiving a voltage that is output by a converter (not shown) that converts a voltage of the fuel cell 112. In addition, the converter 106 may supply power to a motor of the motor unit 114 and the load device 108, which are operated in a high voltage range, at a voltage converted from the fuel cell 112.

The motor unit 114 may generate a driving force by receiving electric power from the battery 110. The motor unit 114 may transmit a driving force to the wheel unit 116, and a wheel may be driven to rotate. For example, the motor unit 114 may be equipped with a motor for transmitting a driving force to the wheel unit 116 and a motor control module for controlling motor torque, a motor turning direction, and braking. The motor unit 114 may be driven by receiving electric power that is applied from the battery 110 via an inverter (not shown). An inverter may convert a specific form of electric power of the battery 110, for example, alternating current to another form, for example, direct current and reduce a voltage. The wheel unit 116 may include a wheel receiving a driving force of the motor unit 114, a main braking module for decelerating the drive of the wheel and a steering module for realizing horizontal control of the wheel.

The shift unit 118 may be equipped a mechanical component that transmits a driving force that is output from the motor unit 114 to the wheel unit 116. For example, the mechanical component may be a combination of a shaft and gears. As another example, the shift unit 118 may shift a driving force and transmit the shifted driving force to the wheel unit 116, together with a module for transmitting a driving force. In the case of a large vehicle, the shift unit 118 may be coupled with a brake assist module, for example, the retarder 124. For example, the retarder 124 may be equipped with a hydraulic or electromagnetic device for suppressing a rotation of a shaft that couples the wheel unit 116 and the motor unit 114. Following a user's brake assist request, the retarder may decelerate the vehicle 100 during downhill driving, irrespective of regeneration and main braking. The brake assist equipment and transmission described above may be omitted according to a specification of the vehicle 100.

In the present disclosure, the motor unit 114, the wheel unit 116, the shift unit 118 and the retarder 124 may constitute the power-train component 126.

In addition, the vehicle 100 may include the memory 120 and the processor 122.

The memory 120 may store an application for controlling the vehicle 100 and various data and load the application or read and record data at a request of the processor 122. In the present disclosure, the memory 120 may have an application that determines an adaptive third forgetting factor of a RLS-based third weight estimation based on estimated weight information generated (e.g., determined) in each of a first weight estimation and a second weight estimation each using the Recursive Least Square (RLS) based on different forgetting factors and generates (e.g., determines) ultimate estimated weight information (e.g., third estimated weight information) from the third weight estimation according to the determined third forgetting factor. The application managed in the memory 120 may be implemented to determine whether or not there is an aggressive update request for the third weight estimation based on a predetermined situation, and in response to the presence of the request, to generate (e.g., determine) ultimate weight information by using aggressive update of the third weight estimation that applies an aggressive forgetting factor to the third forgetting factor. The memory 120 may store vehicle data, a hyper-parameter, and various types of data, which are utilized for weight estimation based on multiple RLSs according to the present disclosure.

The memory 120 may hold and manage map information for identifying a location of the vehicle 100. Map information may be used to generate a driving route set in the vehicle 100 at a request of a user or the processor 122 or to identify a location of the vehicle 100 such as a latitude, a longitude and an altitude. In addition, map information may be used to obtain driving situation information of a front route. In addition, map information may be used for autonomous driving and include a low definition map or include an HD map together with the map. Map information may be provided to have various information and data included in the above-described object and environment.

The processor 122 may perform overall control of the vehicle 100. The processor 122 may be configured to execute an application and an instruction stored in the memory 120.

In relation to the present disclosure, the processor 122 may perform weight estimation based on multiple RLSs according to the present disclosure by using an application, an instruction, and data stored in the memory 120.

Specifically, the processor 124 may execute processing to generate first estimated weight information and second estimated weight information based on vehicle data by using a first weight estimation and a second weight estimation that use RLSs based on a first forgetting factor and a second forgetting factor with different forgetting features respectively, to determine an adaptive third forgetting factor of a third weight estimation that is constructed by a RLS based on the first and second estimated weight information, and to generate ultimate estimated weight information based on vehicle data by using the third weight estimation to which the determined third forgetting factor is applied. Herein, the third forgetting factor may be determined in response to the absence of an aggressive update request. The processor 122 may execute processing to determine, based on a predetermined situation, whether or not there is an aggressive update request for the third weight estimation, and to generate, in response to the request, the ultimate weight information based on vehicle data by the aggressive update of the third weight estimation that applies an aggressive forgetting factor to the third forgetting factor.

In the present disclosure, the processor 122 may be implemented as a single processing module that executes the above-described processing related to weight estimation and processing of various vehicle operations. As another example, the processor 122 may have the above-described processing as distributed processing over a plurality of processing modules. For example, the processor 122 may include a vehicle control unit (VCU), a motor control unit (MCU), an electric brake system (EBS) and a transmission control unit (TCU) and handle the above-described process according to each corresponding module in a distributed manner.

In the present disclosure, for convenience of explanation, even if the processor 124 including a plurality of processing modules performs the above-described processes, the processor 124 illustrated in FIG. 2 is described to commonly refer to the plurality of processing modules.

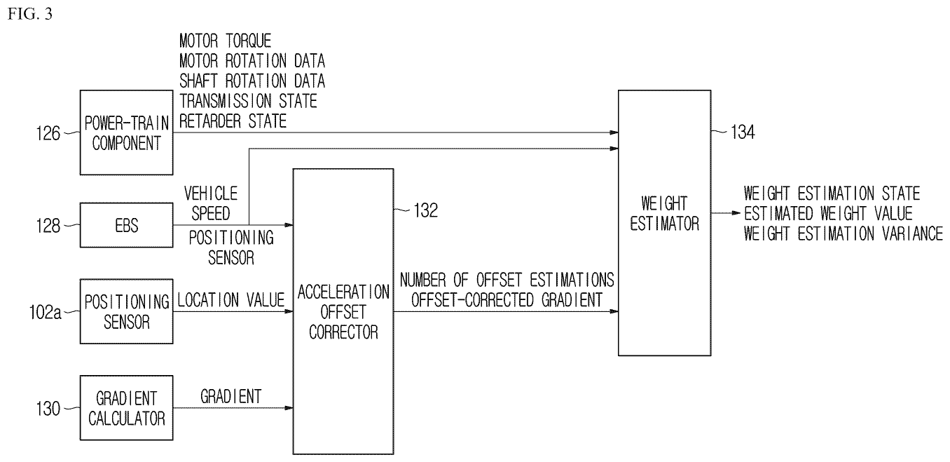

FIG. 3 is a block diagram of a system that implements weight estimation in a vehicle according to an embodiment of the present disclosure.

FIG. 3 mainly illustrates individual modules for weight estimation in FIG. 2 and detailed functional modules of the processor 122. The system may include the power-train component 126, an electronic braking system (EBS) 128, the positioning sensor 102a, a gradient calculator 130, an acceleration offset corrector 132, and a weight estimator 134. Herein, the gradient calculator 130, the acceleration offset corrector 132 and the weight estimator 134 may be designed to be implemented in the processor 122.

The power-train component 126 may output vehicle data from a specific module exemplified in FIG. 2, for example, data used in a longitudinal dynamics model, while the vehicle 100 is being used. For example, the power-train component 126 may output, as vehicle data, a motor torque, motor rotation data, shaft rotation data, a transmission state, a retarder state, and the like. The transmission state may include whether transmission is present or not, a gear ratio and the like, and the retarder state may include whether or not there is an operation of the retarder 124 corresponding to an assist brake device. Although not illustrated in FIG. 3, a vehicle operation state, which is a type of vehicle data, is provided to the weight estimator 134, and the vehicle operation state may be a state in which the start-up (e.g., ignition) of the vehicle 100 is turned from off to on (e.g., the vehicle 100 transitions from an OFF state to an ON state). The EBS 128 may output a value detected from the brake demand level sensor 102c, which functions as a brake pedal sensor, and a vehicle speed as vehicle data. Based on a value obtained from the slope sensor 102b, the gradient calculator 130 may provide a gradient of the vehicle 100 or a road as vehicle data. The acceleration offset corrector 132 may be used to correct a bias and an error that may occur in the gradient calculator 130 by comparing the positioning sensor 102a and the slope sensor 102b that are mounted in the vehicle 100. In addition, the acceleration offset corrector 132 may provide an offset-corrected gradient and also generate and output the number of estimations of acceleration offset correction. The weight estimator 134 may generate ultimate estimated weight information based on vehicle data. For example, the estimated weight information may include an estimated weight value, a weight estimation variance, a weight estimation state, a weight estimation standard deviation, and various types of weight-related data.

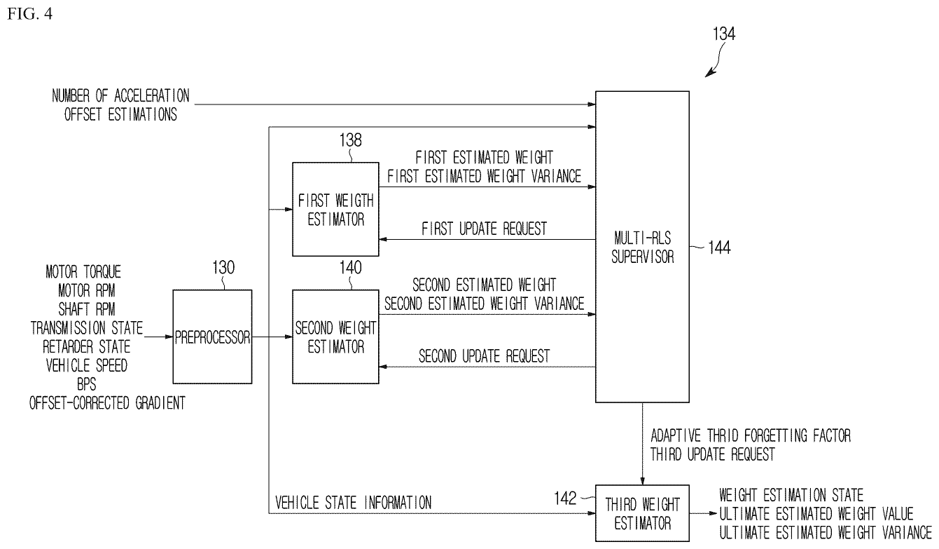

FIG. 4 is a view showing functional modules of a weight estimator. FIG. 4 shows detailed functional modules of the weight estimator 134 of FIG. 3.

The weight estimator 134 may include a preprocessor 136, a first weight estimator 138, a second weight estimator 140, a third weight estimator 142, and a multi-RLS supervisor 144.

The preprocessor 136 may convert the vehicle data listed in FIG. 2 to a predetermined form of vehicle state information such as a parameter value of a longitudinal dynamics model.

Each of the first weight estimator 138 and the second weight estimator 140 may include a RLS estimator based on a first forgetting factor and a second forgetting factor respectively, a postprocessor for generating estimated weight information based on a value output from the RLS estimator, and a filter for reducing variability of values of estimated weight information that is successively output. The first weight estimator 138 may use the first forgetting factor that has a high forgetting feature for aggressive update of weight estimation. An aggressive forgetting factor may indicate a forgetting feature that is associated with an increased forgetting rate (e.g., relative to a non-aggressive forgetting factor). On the other hand, a conservative forgetting factor may indicate a forgetting feature that is associated with a decreased forgetting rate (e.g., relative to a non-conservative forgetting factor). The first weight estimator 138 may perform a first weight estimation that generates first weight estimation information based on vehicle state information. The first weight estimation information may include a first estimated weight, a first estimated weight variance, a first weight estimation standard deviation, and various types of data related to weight. For conservative update of weight estimation, the second weight estimator 140 may use the second forgetting factor with a lower forgetting feature than the first forgetting factor. The second weight estimator 140 may perform a second weight estimation that generates second weight estimation information based on vehicle state information. The second weight estimation information may include a second estimated weight, a second estimated weight variance, a second weight estimation standard deviation, and various types of data related to weight. Herein, the first and second forgetting factors may be provided as a fixed value.

In practice, in the same way as the first and second weight estimators 138 and 140, the third weight estimator 142 may include an RLS estimator, a postprocessor and a filter. The third forgetting factor, which is used in the third weight estimator 142, varies differently from the first and second forgetting factors and specifically may be adaptively determined according to the first and second weight estimation information or a predetermined vehicle state. By using the adaptive third forgetting factor, the third weight estimator 142 may perform a third weight estimation that generates ultimate estimated weight information. The ultimate estimated weight information may include the data described in FIG. 2.

Based on the first and second estimated weight information, the number of estimations of acceleration offset and vehicle state information, the multi-RLS supervisor 144 may check whether or not there is an aggressive update request for the third weight estimator 142 and determine and provide a third forgetting factor according to whether or not the request is present to the third weight estimator 142. Based on the above-described information, the multi-RLS supervisor 144 may request update of weight estimation for the first to third weight estimators 138, 140 and 142.

The longitudinal dynamics model for generating vehicle state information based on vehicle data, as described above, will be described through Equation 1 below. In the present disclosure, the longitudinal dynamics model may be referred to as a longitudinal dynamics equation.

$${\dot{v}}_{Lon} + g ( μ cos ( θ ) + sin ( θ ) ) = ( \frac{{g}_{gbx} {g}_{rear}}{{r}_{tire}} ( ϵ ( τ , {ω}_{in} , {ω}_{out} ) τ - J \dot{ω} ) - \frac{1}{2} {C}_{d} ρ {Av}^{2} ) \frac{1}{M} \qquad [ Equation l ]$$

In Equation 1, parameters have the following meaning.

\dot{v}_{Lon} is a change rate of a longitudinal velocity and may be estimated using a Kalman filter based on a vehicle speed. θ may be an offset-corrected gradient. In a specific situation like vehicle breakdown, a gradient including an offset may be input as θ for a predetermined time. In this case, if the number of corrections (or number of estimations) of the acceleration offset corrector 132 increases, it may be determined that correction is normally performed. g is the gravitational acceleration of 9.8 m/s², and μ may be a rolling resistance constant such as 0.008. In the case of a vehicle with a transmission, g_{gbx} may be a gear ratio of a current transmission stage, and in the case of a vehicle with a decelerator, it may be a deceleration ratio. gᵣₑₐᵣ is a rear axle ratio and may be defined as 1 when there is no separate rear axle. rₜᵢᵣₑ is a tire dynamic radius, which may be 0.5 m for example, and ∈(t, ωᵢₙ, ωₒᵤₜ) is power-train efficiency (0-1) that may be experimentally determined. τ may be a motor torque Nm, wᵢₙ may be an input-shaft rpm, and Wout may be an output-shaft rpm. J may be an effective inertia moment (kg·m²) of power-train, which may be experimentally determined. ω is an angular acceleration (rad/s²) and may be calculated from a motor RPM.

C_{d} is an aerodynamic coefficient and may be experimentally determined. ρ may be determined by atmospheric density, altitude and ambient temperature. A is an effective front area of a vehicle, v is a relative speed of the vehicle with respect to the ambient air and depends on the impact of wind speed, but the wind speed may be assumed to be 0 when weight is estimated. M may be the mass (kg) of a vehicle.

The first to third weight estimators 138, 140 and 142 may include a recursive least square (RLS) estimator that uses RLS with forgetting factor. The RLS with forgetting factor will be described below.

$$y = Φ x \qquad [ Equation 2 ]$$

RLS may be expressed in a linear parametric form as Equation 2 using a given observed value y, an estimating x and a function Φ. In this case, a RLS estimation may be calculated by a series of equations, specifically,

$$\hat{x} ( k ) = \hat{x} ( k - 1 ) + L ( k ) ( y ( k ) - {Φ}^{T} ( k ) \hat{x} ( k - 1 ) ) , L ( k ) = P ( k - 1 ) Φ ( k ) {( {λ}_{k} + {Φ}^{T} ( k ) P ( k - 1 ) Φ ( k ) )}^{- 1} , P ( k ) = \frac{1}{{λ}_{k}} ( 1 - L ( k ) {Φ}^{T} ( k ) ) P ( k - 1 ) .$$

In the equations, k may mean the number of updates of weight estimation performed in a weight estimator or a step index of weight estimation. Here, the forgetting factor λₖ may determine a forgetting degree of past observation information. If λ=1, a RLS algorithm may be implemented not to forget past observation information or past estimation result at all. As λ approaches 0, RLS may aggressively forget the past estimation result and determine observation information that is as close to the present as possible. As described above, in the present disclosure, a first forgetting factor and a second forgetting factor are not variable over time, and only a third forgetting factor may be variable over time. In the present disclosure, the weight of a vehicle is to be ultimately estimated, the variable x to be estimated may be defined as a reciprocal of scaled mass as shown in Equation 3.

$$x = \frac{{M}_{0}}{M} \qquad [ Equation 3 ]$$

M₀ is reference mass and may be suitably selected by considering a numerical error of an algorithm. The longitudinal dynamics equation according to Equation 1 may be arranged

$${\dot{v}}_{Lon} + g ( μ cos ( θ ) + sin ( θ ) ) and Φ = \frac{1}{{M}_{0}} ( \frac{{g}_{gbx} {g}_{rear}}{{r}_{tire}} ( ϵ ( τ , {ω}_{in} , {ω}_{out} ) τ - J \dot{ω} ) - \frac{1}{2} {C}_{d} ρ {Av}^{2} ) by Equation 3.$$

Thus, if RLS and the longitudinal dynamics equation are applied, an estimation \hat{x} of the weight-related variable x may be obtained. As shown in Equation 4 below, the weight estimation \hat{M} may be obtained through î.

$${\hat{M}}_{k} = \frac{{M}_{0}}{\hat{x}} , \qquad [ Equation 4 ]$$

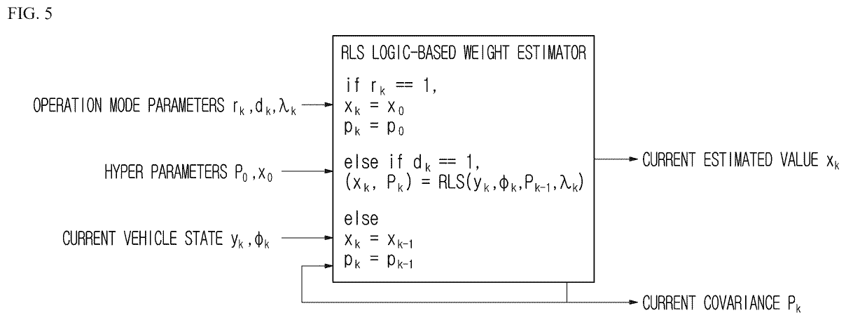

Referring to FIG. 5, the structure of a RLS estimator used in each weight estimator will be described. FIG. 5 is a view showing RLS logic that is applied to a weight estimator.

The RLS estimator may generate a current estimated value based on an operation mode parameter, current vehicle state information, and a past covariance of estimated values and a covariance thereof.

Operation mode parameters rₖ and dₖ transmitted by the multi-RLS supervisor 144 may each indicate a reset state related to whether or not RLS is reset and whether or not update is permitted. The multi-RLS supervisor 144 may transmit rₖ as 1 in a vehicle operation state like initial start-up and initialize RLS. For example, the multi-RLS supervisor 144 may determine adequacy of the longitudinal dynamics equation based on detection of abnormality of a current sensor state, whether or not a retarder operates and other vehicle data used for weight estimation and output dₖ as 1. Meanwhile, only in the case of a third weight estimator, the multi-RLS supervisor 144 may vary a forgetting factor λₖ according to time and use a predefined constant for another forgetting factor.

Meanwhile, because an estimated value x is calculated through RLS, it is not necessary to convert x to a vehicle weight. Specifically, by the above-described equation

$${\hat{M}}_{k} = \frac{{M}_{0}}{{x}_{k}} ,$$

x may be converted to a vehicle weight \hat{M}ₖ. A weight estimation variance may be calculated by

$$P ( {\hat{M}}_{k} ) = P ( {x}_{k} ) {( \frac{dM}{dx} )}^{2} ,$$

and a weight estimation standard deviation may be obtained by

$$S T D ( {\hat{M}}_{k} ) = \vert \frac{dM}{dx} \vert \sqrt{P ( {x}_{k} )} = \frac{{\hat{M}}_{k}}{x} \sqrt{P ( {x}_{k} )} .$$

Meanwhile, if the forgetting factor λ is small and an input observed value yₖ or a noise level of the function Φₖ or a level of effect not included in the model is high, chattering of an output result of RLS may be caused. In the present disclosure, the chattering needs to be prevented by using an RLS result with A being set to be small so that a convergence speed may be improved and fail-safety may be achieved for a situation where weight estimation is impossible. A simple lowpass filter is capable of preventing chattering, but the use of the simple lowpass filter may not be suitable when a sudden change of filter output is physically acceptable like initial weight estimation or a sudden change of vehicle weight caused by a fallen object. In the present disclosure, a filter used in a weight estimator may be an adaptive rate-limit filter. In addition to chattering prevention, the filter may have a filter output quickly approach a filter input according to a specific situation. The adaptive rate-limit filter may be a filter that prevents an output from being excessively changed from a previous output at each operation cycle time of individual logic. For an estimated weight \hat{M}ₖ, \hat{M}₀=M̅₀; f_{u,k}≥M̅ₖ−M̅ₖ₋₁≥f_{l,k}, f_{u,k}≥0, f_{l,k}≤0 may be applied between an adaptive rate-limit filter output M̅ₖ₋₁ of a previous step and a current filter output M̅ₖ. Specifically, a filter output may be determined by the following process.

$$if {\hat{M}}_{k} > {\overline{M}}_{k - 1}$$

$$[ if {\hat{M}}_{k} > {\overline{M}}_{k - 1} + {f}_{u , k} , {\overline{M}}_{k} = {\overline{M}}_{k - 1} + {f}_{u , k} , else {\hat{M}}_{k} = {\overline{M}}_{k - 1} ]$$

$$else$$

$$[ if {\hat{M}}_{k} < {\overline{M}}_{k - 1} - {f}_{l , k} , {\overline{M}}_{k} = {\overline{M}}_{k - 1} - {f}_{l , k} , else {\hat{M}}_{k} = {\overline{M}}_{k - 1} ]$$

Meanwhile, the upper and lower rate limits of a filter may be adaptively determined by a filter input/output deviation. That is, if there is a large deviation between a filter input and a filter output, the filter output may quickly follow a weight estimation result by increasing f_{u,k} and f_{l,k} and if the deviation is small, an unnecessary fluctuation of filter output may be suppressed by decreasing f_{u,k} and f_{l,k}. This may be expressed by ΔMₖ=|\hat{M}ₖ−M̅ₖ|,f_{u,k}=fᵤ(ΔMₖ₋₁), f_{l,k}=fₗ(ΔMₖ₋₁). Herein, the functions f_{u,k} and f_{l,k} may be experientially determined. For example, the above-described functions f_{u,k} and f_{l,k} may be defined as piecewise linear function. In an actual application, tuning may be needed because of a noise level of each sensor or a characteristic of a vehicle.

To sum up, each weight estimator may perform RLS estimation based on hyper parameters P₀, x₀ and M₀, vehicle state information and operation mode parameters rₖ, dₖ and λₖ that are determined based on a weight estimation result. A postprocessor may calculate an estimated weight and a standard deviation based on an output value of RLS, and a filtered estimated weight M̅ₖ may be calculated by utilizing an adaptive rate-limit filter for preventing chattering. The ultimate output of each weight estimator may be weight estimation values \hat{M}ₖ and M̅ₖ and a standard deviation STD (\hat{M}ₖ) of the current estimation.

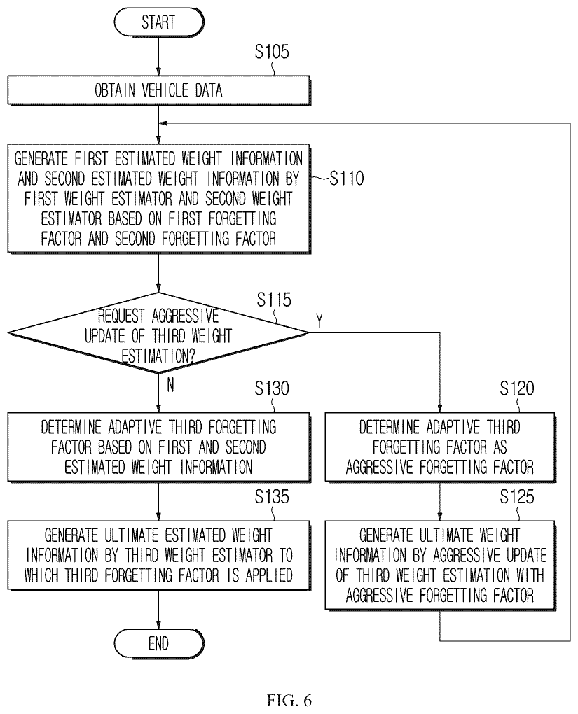

Hereinafter, the weight estimation method of this embodiment according to FIG. 3 and FIG. 4 will be described in detail through FIG. 6 to FIG. 11. The weight estimation method may be processed mainly by the processor 122 of the vehicle 100, and the processor 122 and the vehicle 100 may be described interchangeably. FIG. 6 is a flowchart of a method for estimating a weight according to another embodiment of the present disclosure.

First, the processor 122 of the vehicle 100 may be operated by the use of a user and obtain vehicle data (S105).

For example, the use of the user may be that the start-up of the vehicle 100 is turned from off to on and becomes capable of driving. The vehicle data may be the data described in FIG. 3, that is, data used in a longitudinal dynamics equation.

Next, the processor 122 of the vehicle 100 may generate first estimated weight information and second estimated weight information based on the vehicle data through the first weight estimator 138 and the second weight estimator 140 that use RLS based on a first forgetting factor and a second forgetting factor respectively (S110).

The second forgetting factor may have a lower forgetting feature than the first forgetting factor but have a greater value than the first forgetting factor. Accordingly, the first weight estimator 138 may perform an aggressive weight estimation as a first weight estimation, and the second weight estimator 140 may perform a conservative weight estimation as a second weight estimation as compared to the first weight estimator 138. The generation of the first and second estimated weight information is actually the same as described through FIG. 3 to FIG. 5.

Next, the processor 122 may determine whether or not there is an aggressive update request for the third weight estimator 142, based on a vehicle operation state, a weight estimation error state related to a divergence state of the first weight estimation, or a difference between the first estimated weight information and the second estimated weight information (S115).

The vehicle operation state may include a state where the start-up of the vehicle 100 is turned from off to on (e.g., the vehicle 100 transitions from an OFF state to an ON state). In case the start-up is off, a reset state rₖ is given 1, for example, and in case the start-up is on, the reset state may be designated as 0. Herein, an aggressive update request may occur only when there is a change in the reset state corresponding to a vehicle operation state where the start-up is turned from off to on, that is, when the reset state is changed from 1 to 0. In addition, the vehicle operation state may be an operation state of a module of the vehicle 100 involved in weight estimation. For example, a module for outputting vehicle data for weight estimation may be a power-train component 126 or a sensor related to a vehicle speed or brake demand level (e.g., EBS 128, wheel speed sensor 102d). If the operation state of the modules is detected as failure, the reset state becomes 1 and a reset command may be generated. A detailed content of an aggressive update request related to a vehicle operation state will be described below.

A request of aggressive update may occur depending on whether or not the weight estimation error state eₖ exists. The weight estimation error state may have a different value according to whether or not the first estimated weight information of the first weight estimator 138 diverges according to a predetermined criterion. If the first estimated weight information diverges according to the predetermined criterion, the weight estimation error state may be designated as 1, and if the first estimated weight information does not diverge, the weight estimation error state may be shown to be 0. For example, the divergence, where the weight estimation error state is shown to be 1, may occur because correction of the acceleration offset corrector 132 is not performed either temporarily or normally. For example, when correction of an acceleration offset is not performed either temporarily or normally because of a change of gradient during driving or a replaced component of the vehicle 100, unstable variability of vehicle data that is input into the first weight estimator 138 may cause the divergence of the first weight estimation.

In addition, apart from the above-described event, the request of aggressive update may occur in response to a difference between the first and second estimated weight information, which is caused by a sudden weight change of the vehicle 100 while the vehicle 100 is being driven. For example, the sudden weight change may be caused by a falling object from the loaded vehicle 100.

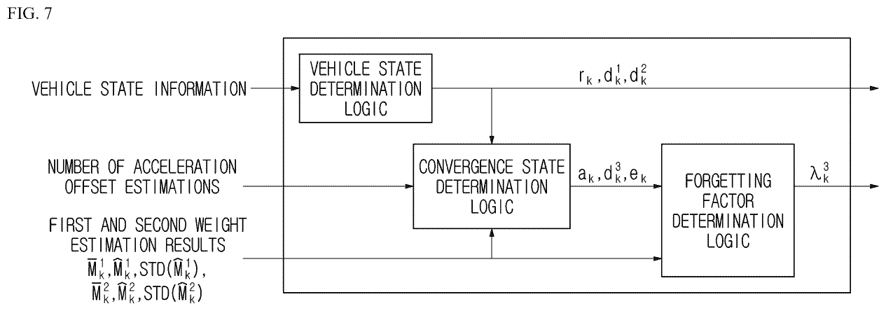

Determination regarding whether or not there is an aggressive update is processed by the multi-RLS supervisor 144, which will be described in detail with reference to FIG. 7 to FIG. 10. FIG. 7 is a view showing logic that is processed in a multi-RLS supervisor.

The multi-RLS supervisor 144 may determine whether or not there is an aggressive update and also generate an adaptive third forgetting factor for delivering to the third weight estimator 142. In order to execute what is described above, the multi-RLS supervisor 144 may functionally include a vehicle state determination logic, a convergence state determination logic and a forgetting factor determination logic and process these logics.

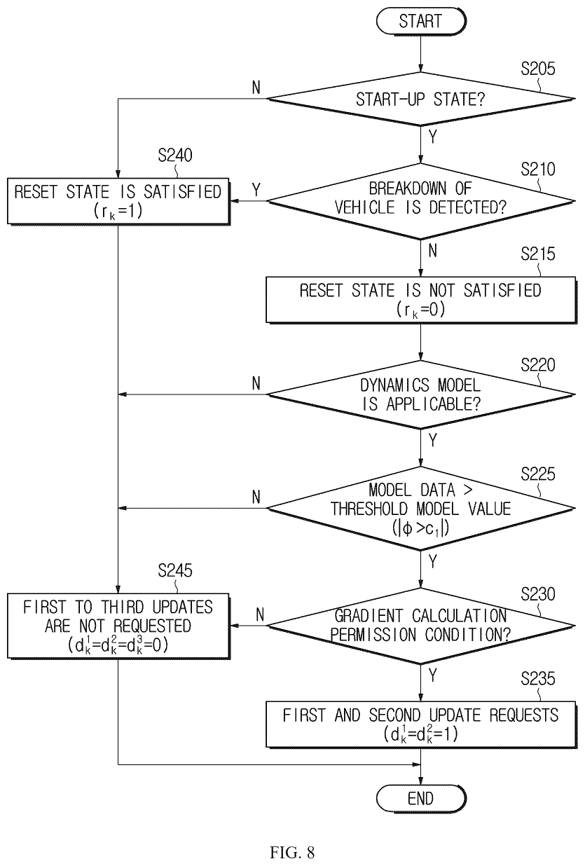

The vehicle state determination logic will be described with reference to FIG. 8. FIG. 8 is a flowchart of a process performed in a vehicle state determination logic.

The processor 122 of the vehicle 100 may check whether the start-up state is on or off (S205), and if the start-up state is on, the processor 122 may detect whether or not a module of the vehicle 100 for outputting vehicle data for weight estimation breaks down (S210). For example, the module of the vehicle 100 may be the power-train component 126 or the EBS 128. In case the module does not break down, the processor 122 may determine, as the vehicle operation state, a reset state rₖ of 0 corresponding to dissatisfaction and deliver it to the convergence state determination logic (S215). Herein, the subscription k is a discretized time index of weight estimation that is performed in time series in a weight estimator, and in the present disclosure, it may be referred to as a step index.

The processor 122 may determine whether or not an operation state of the module of the vehicle 100 for outputting vehicle data is applicable to the above-described longitudinal dynamics equation (S220). For example, lockup release of a torque converter, operation of a hydrodynamic retarder, and operation of a service brake may be operation states for which modeling by the dynamics equation is difficult.

In case no operation state occurs for which modeling is difficult, the processor 122 may determine whether or not model data Φ in y=Φx according to Equation 2 is greater than a constant c₁ that is a threshold model value (S225). When Φ approaches 0, x becomes more indeterminable by an observed value y, and as the impact of observation noise on the error of x increases, step S225 may be performed. For example, c₁ may be set to 0.1.

In case the model data Φ is greater than the threshold model value c₁, the processor 122 may determine whether or not a gradient calculation permission condition for the acceleration offset corrector 132 is satisfied (S230). Because gradient calculation is used as an input factor of weight estimation, the processor 122 may check whether or not there is a gradient update prohibition condition. If the gradient calculation permission condition is satisfied, the processor 122 may transmit a signal for requesting update of the first and second weight estimations to the first and second weight estimators 138 and 140 (S235). The requesting signal may be generated to designate a first update request

$${d}_{k}^{1}$$

and a second update request

$${d}_{k}^{2}$$

as 1.

At step S205 and step S210, if the start-up state is off or the module of the vehicle 100 is detected to break down, the processor 122 may determine, for the vehicle operation state, the reset state rₖ as 1, which corresponds to satisfaction, deliver it to the convergence state determination logic and transmit a signal for requesting not to perform the update of the first to third weight estimations to the first to third weight estimators 142 (S245). The signal for not to perform may be generated to designate the first update request

$${d}_{k}^{1} ,$$

second update request

$${d}_{k}^{2}$$

and a third update request

$${d}_{k}^{3}$$

as 0.

Even when the reset state does not occur at step S215, if the operation state of the module of the vehicle 100 for outputting vehicle data at step S220 is not applicable to the longitudinal dynamics equation, the signal for requesting not to perform the update of the first to third weight estimations may be transmitted to the first to third weight estimators 142 (S245). In addition, if at step S225 the model data Φ is smaller than the constant c₁, which is the threshold model value or if at step S230 the gradient calculation permission condition is not satisfied, the processor 122 may transmit the signal for requesting not to perform the update of the first to third weight estimations to the first to third weight estimators 142 (S245).

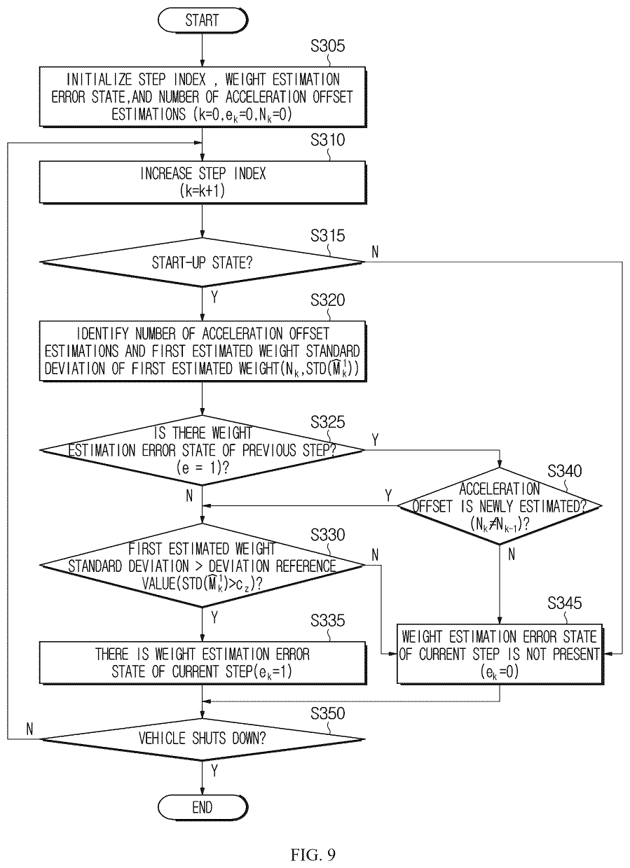

Hereinafter, the convergence state determination logic will be described with reference to FIG. 9. FIG. 9 is a flowchart of a process of determining weight estimation error, which is performed in the convergence state determination logic.

The processor 122 may initialize a step index k, a weight estimation error state eₖ, and the number of acceleration offset estimations Nₖ to 0 (S305). The logic related to weight estimation error determination may output the weight estimation error state eₖ as a value that is not 0, only when the start-up state is on, and a weight estimation error state may be determined according to the process of FIG. 9, when the vehicle operation state is on. The number of acceleration offset estimations Nₖ may be the number of acceleration offset estimations that have been received when the k-th step index is executed. If there is no new estimation of acceleration estimation, Nₖ=Nₖ₋₁.

While the step index increases (S310), if the start-up state is on (Y of S315), the processor 122 may identify the number of acceleration offset estimations and the first estimated weight information of the first weight estimator 138 (S320). The first weight estimator 138 may generate the first estimated weight information by a first update request, and the identified first estimated weight information may be a standard deviation

$$S T D ( {\hat{M}}_{k}^{1} )$$

of the first estimated weight for the first estimated weight. Meanwhile, at step S315, if the start-up state is off (N of S315), it may be determined that there is no weight estimation error state of the current step.

Next, the processor 122 may determine whether or not there is a weight estimation error state of a previous step (k−1) (S325). Specifically, the processor 122 may check whether or not eₖ₋₁ is 1. If there is no weight estimation error state of the previous step, the processor 122 may detect whether or not the standard deviation

$$S T D ( {\hat{M}}_{k}^{1} )$$

of the first estimated weight is greater than a deviation reference value c₂ (S330). The deviation reference value may be 30,000 kg. If the standard deviation is greater than the deviation reference value, the processor 122 may determine that there is a weight estimation error state of the current step (eₖ=1) (S335).

Meanwhile, if at step S325 there is a weight estimation error state of the previous step (eₖ₋₁=1), the processor 122 may determine, by the acceleration offset corrector 132, whether or not there is a new estimation of acceleration offset (S340). If there is no new estimation (Nₖ=Nₖ₋₁), the processor 122 may maintain or determine that there is no weight estimation error state of the current step (eₖ=0). On the other hand, if there is a new estimation (Nₖ≠Nₖ₋₁), the processor 122 may proceed to step S330 and determine whether or not a current weight estimation error state occurs, based on a current standard deviation of the first weight estimation.

After it is determined at step S335 and step S350 whether or not there is a weight estimation error state of the current step, if there is no shutdown of the vehicle 100 (N of S350), steps S310 to S350 may be repeated to check whether or not there is a weight estimation error state of a next step.

The logic related to weight estimation error may generate a signal related to a weight estimation error state and prevent estimate values from chattering because of the signal, when a normal weight estimation is impossible because of abnormal correction of the acceleration offset corrector 132 that is attributable to an abnormal behavior of an accelerometer.

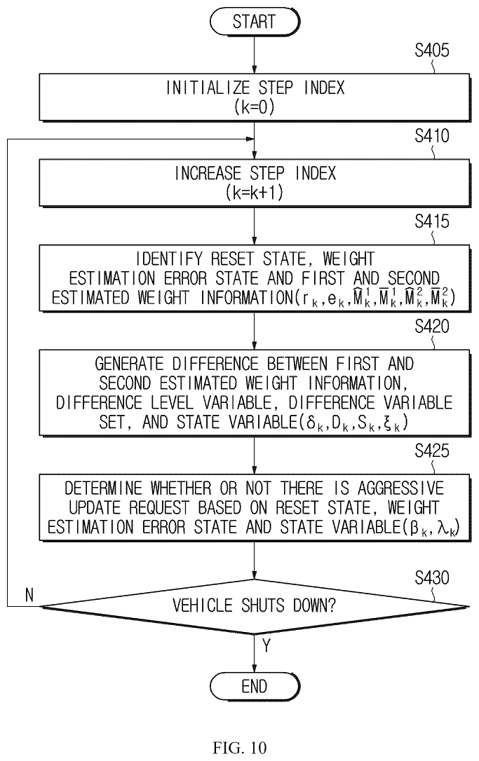

Hereinafter, the forgetting factor determination logic will be described with reference to FIG. 10. FIG. 10 is a flowchart of a process related to an aggressive update request of convergence state determination logic.

The processor 122 of the vehicle 100 may initialize a step index (S405) in order to follow a step index of steps S305 and S310, similar to these steps, and increase the step index (S410).

Next, the processor 122 may identify the state and information of a current step received from a vehicle state determination logic, a convergence state determination logic and the first and second weight estimators 138 and 140, that is, a reset state rₖ, a weight estimation error state eₖ and first and second estimated weight information

$${\hat{M}}_{k}^{1} , {\overline{M}}_{k}^{1} , {\hat{M}}_{k}^{2} , {\overline{M}}_{k}^{2} ( S 415 ) .$$

Next, the processor 122 may generate a difference between the first and second estimated weight information, a difference level variable, a difference variable set, and a state variable (S420).

Step S420 may generate data that is used to determine whether or not there is an aggressive update request according to the difference between the first and second estimated weight information.

In relation to the generated data, as for the difference between the first and second estimated weight information, a variable representing a difference between estimated weight information output from the first and second weight estimators 138 and 140 may be defined as δₖ for each step index k. As shown in Equation 5 below, δₖ may be defined as a function of first and second estimated weights

$${\hat{M}}_{k}^{1} and {\hat{M}}_{k}^{2}$$

and filtered first and second estimated weights

$${\overline{M}}_{k}^{1} and {\overline{M}}_{k}^{2}$$

calculated by an adaptive rate-limit filter.

$${δ}_{k} = g ( {\hat{M}}_{k}^{1} , {\overline{M}}_{k}^{1} , {\hat{M}}_{k}^{2} , {\overline{M}}_{k}^{2} ) \qquad [ Equation 5 ]$$

For example, the equation below may be described as Equation 6 below.

$${δ}_{k} = \vert {\overline{M}}_{k}^{1} - {\hat{M}}_{k}^{2} \vert \qquad [ Equation 6 ]$$

The above equation may be provided by considering that an unnecessary aggressive update request may occur according to a setting parameter of a filter when a behavior of the second weight estimator 140 conservatively changes. As shown in Equation 7, an aggressive update request may be determined based on a reset condition, determination of a weight estimation error state, and a difference between first and second estimated weight information.

$${a}_{k} = a ( {δ}_{[ \cdot ]} , {r}_{[ \cdot ]} , {e}_{[ \cdot ]} ) \qquad [ Equation 7 ]$$

In the above equation, subscripts are omitted because it is considered that aₖ is determined by utilizing multiple pieces of past data, if necessary.

An aggressive update request according to a difference between first and second estimated weight information may be determined as follows. First, a difference level variable, that is, a logic variable Dₖ may be determined by Equation 8 (or logic equation) below.

$${D}_{k} = \{ \begin{matrix}0 , & k \leq 0 \\ {δ}_{k} > {c}_{3} , & k > 0\end{matrix} \qquad [ Equation 8 ]$$

If the above logic equation is true, the logic variable may be 1, and if the above logic equation is not true, the logic variable may be 0. Here, c₃ is a constant representing a difference level between first and second estimated weight information, and for example, if a maximum weight is about 35 tons like a large truck, c₃ may be set to 40,000 kg. In addition, a difference variable set Sₖ may be defined as Sₖ={D_{k-N}_{ᵥ}₊₁, D_{k-N}_{ᵥ}₊₂, . . . , Dₖ}. Thus, Sₖ may be a set of D[⋅] as many as the past windows Nᵥ. A state variable ξₖ may be defined as ξₖ=min(Sₖ). For example, k>100, Nᵥ=100 and 10 seconds are set, the value of ξₖ may be 1 only if the logic equation Dₖ is true 100 times successively. That is, ξₖ is set to 1 if the D[⋅] signal is continuously true during the past Nᵥ counts, and ξₖ is set to 0 if the D[⋅] signal is false one or more times during the past Nᵥ counts.

Next, the processor 122 may determine whether or not there is an aggressive update request for the third weight estimator 142, based on a reset state as a vehicle operation state, a weight estimation error state, or a difference between the first estimated weight information and the second estimated weight information (S425).

A logic variable βₖ for determining whether or not the request exists may be determined as in Equation 9 below. In the equation below, ‘∥’ is an OR operator.

$${β}_{k} = \{ \begin{matrix}0 , & k \leq 0 \\ [ {r}_{k} == 1 ‖ {e}_{k} == 1 ‖ ( {ξ}_{k} > {ξ}_{k - 1} ) ] , & k > 0\end{matrix} \qquad [ Equation 9 ]$$

As can be known in the above equation, if there is an event where a reset station rₖ is 0, a weight estimation error state eₖ occurs or a difference of state variable between previous and current steps occurs based on a difference between first and second weight information, a precondition related to the presence of an aggressive update request aₖ may be considered to be satisfied. In case the reset state rₖ or the error state eₖ is true in the above condition, the third weight estimator 142 is prohibited from weight estimation update. On the other hand, as described below, by a logic for maintaining a predetermined number of aggressive update requests, when the reset state rₖ or the error state eₖ is true, a weight estimation update is prohibited at the moment, but an aggressive update may be performed a predetermined number of times from the moment the prohibition condition is withdrawn.

The processor 122 maintains a state according to an event for a predetermined duration of time, and if the processor 122 detects during the maintained state that start-up is turned on, a normal acceleration offset is corrected or a difference of state variables is kept, the processor 122 may generate a request of aggressive update after the predetermined duration of time terminates. To sum up, in the case of an aggressive update request related to a weight estimation error state and a reset state, after a normal weight estimation is implemented because of turning-on of start-up or an acceleration offset is corrected, an aggressive update request of the third weight estimator 142 occurs, and thus ultimate weight information according to the aggressive update may be generated. As for an aggressive update request according to the difference, if a continuous difference between first and second estimated weight information is greater than a threshold difference, an aggressive update request may be activated.

A determination condition set Tₖ that accumulated as many as N_{w} in the past and the aggressive update request aₖ may be defined as Tₖ={β_{k-N}_{_{w}}₊₁, β_{k-N}_{_{w}}₊₂, . . . , βₖ} and aₖ=max (Tₖ) respectively.

When β[⋅] is detected as 1 at any time, the processor 122 may request the third weight estimator 142 to perform an aggressive update a predetermined number of update times N_{w}. For example, N_{w} may be 1,200 times, that is, 120 seconds. When the reset state or the weight estimation error state is 0 in the above equations, if a past difference between first and second estimated weight values was equal to or smaller than c₃ but a difference between estimated weights continuously exceeds c₃ during a predetermined number of counts, that is, for a predetermined duration of time or longer, the physical situation of the vehicle 100 is estimated to have changed because of a fallen load, and the above equations may mean that a weight estimation is aggressively updated for the time N_{w} (or number of times). Meanwhile, steps S410 to S425 may be repeated until the vehicle 100 shuts down (S430).

Referring to FIG. 6 again, when an aggressive update request for the third weight estimator 142 occurs at step S115, the processor 122 of the vehicle 100 may determine an adaptive third forgetting factor as a preset aggressive forgetting factor through a forgetting factor determination logic and deliver the aggressive forgetting factor and a third update request to the third weight estimator 142 (S120).

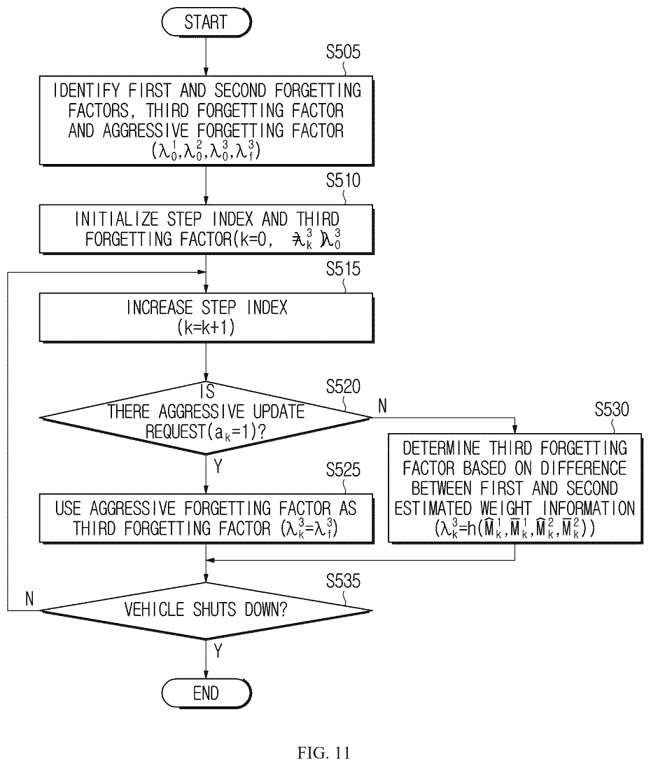

Step S120 will be described with reference to FIG. 11. FIG. 11 is a flowchart of a process that is performed in determination logic of a forgetting factor.

The processor 122 may identify, according to a step index k, initial values of the first and second forgetting factors

$${λ}_{0}^{1} and {λ}_{0}^{2}$$

and the third forgetting factor

$${λ}_{0}^{3}$$

respectively and an aggressive forgetting factor

$${λ}_{f}^{3} \qquad ( S 505 ) .$$

Next, the processor 122 may initialize the step index and the third forgetting factor (S510) and increase the step index (S515).

Next, if an aggressive update request for the third weight estimator 142 occurs (Y of S520, aₖ=1), the third forgetting factor

$${λ}_{k}^{3}$$

may use the preset aggressive forgetting factor

$$\begin{matrix}{λ}_{f}^{3} & (\end{matrix} S 525 ) .$$

The aggressive forgetting factor may not be determined based on first and second estimated weight information but may be set to a preset value. The aggressive forgetting factor may be determined according to a design specification so as to forget as much past data as possible and to preferably depend on data closer to the present.

Next, the processor 122 may generate ultimate weight information based on vehicle data by an aggressive update of the third weight estimator 142 with the aggressive forgetting factor during a number of times or a time required by the aggressive update request (S125).

The third forgetting factor of the third weight estimator 142, which performs the aggressive update, is not affected by estimated weight information caused by the update of the first and second weight estimators 138 and 140, and even if a preset value is used, while the aggressive update is performed, an update of weight estimation by the first and second weight estimators 138 and 140 may be performed. This is intended to enable the divergence and difference of the first and second estimated information to converge on and approach actual weight information, while the aggressive update is performed, and the third forgetting factor to be determined based on the converging information. After a third weight estimation is performed by the aggressive update, the processor 122 may proceed to step S115.

Meanwhile, when there is no aggressive update request for the third weight estimator 142 at step S115, the processor 122 may determine an adaptive third forgetting factor based on the first and second estimated weight information through the forgetting factor determination logic and deliver the determined third forgetting factor and a third update request to the third weight estimator 142 (S130).

In relation to step S130, referring to FIG. 11, if an aggressive update request for the third weight estimator 142 does not occur (Y of S520, aₖ=0), the processor 122 may determine the third forgetting factor based on a difference between first and second estimated weight information according to the update of weight estimation in the first and second weight estimators 138 and 140 (S330). Step S515 to S530 may be repeated until the vehicle shuts down.

As shown in Equation 10 below, an adaptive third forgetting factor

$${λ}_{k}^{3}$$

may vary based on weight estimation information of the first and second weight estimators 138 and 140.

$${λ}_{k}^{3} = h ( {\hat{M}}_{k}^{1} , {\overline{M}}_{k}^{1} , {\hat{M}}_{k}^{2} , {\overline{M}}_{k}^{2} ) \qquad [ Equation 10 ]$$

For example, the third forgetting factor

$${λ}_{k}^{3}$$

may be differently determined according to each section of difference between first and second estimated weight information, as shown in Equation 11.

$${λ}_{k}^{3} = h ( {\hat{M}}_{k}^{1} , {\overline{M}}_{k}^{1} , {\hat{M}}_{k}^{2} , {\overline{M}}_{k}^{2} ) = \{ \begin{matrix}\begin{matrix}{λ}_{min}^{3} , & {δ}_{k} < {c}_{5}\end{matrix} \\ \begin{matrix}\frac{{λ}_{max}^{3} - {λ}_{min}^{3}}{{c}_{6} - {c}_{5}} ( {δ}_{k} - {c}_{5} ) + {λ}_{min}^{3} , & {c}_{5} \leq 0 \leq {c}_{6}\end{matrix} \\ \begin{matrix}{λ}_{max}^{3} , & {δ}_{k} > {c}_{6}\end{matrix}\end{matrix} \qquad [ Equation 11 ]$$

As described above, the first and second forgetting factors

$${λ}_{k}^{1} and {λ}_{k}^{2}$$

may not vary over time but be fixed. In the above equation, the parameters may be set, for example, as the first forgetting factor of

$${λ}_{0}^{1} = 0.95 ,$$

the second forgetting factor of

$${λ}_{0}^{2} = 0.9 \; 99 , \qquad {λ}_{min}^{3} = 0 \text{.99} , \qquad {λ}_{max}^{3} = 0.999 ,$$

c₅=2,000 kg and c₆=4000 kg. The above-listed forgetting factors may be experientially determined according to a sensor measurement value and a level of disturbance, which are used as inputs of a longitudinal dynamics model.

Next, the processor 122 may generate ultimate estimated weight information based on vehicle data by the third weight estimator 142 to which the determined third forgetting factor is applied (S135). Meanwhile, if no aggressive update request occurs after the aggressive update of the third weight estimator 142, the processor 122 may generate the ultimate estimated weight information by using the third weight estimator 142 through steps S130 and S135.

Next, the processor 122 may check whether or not start-up terminates after generating the ultimate estimated weight information. If the processor 122 confirms that the start-up has not terminated, the processor 122 repeats the process following step S110 again.

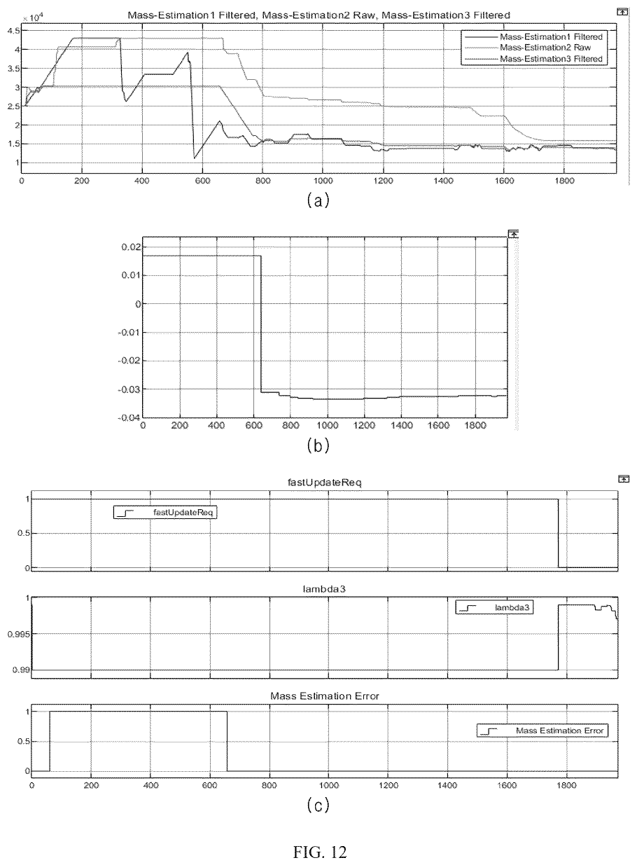

FIG. 12 is a view showing data of a result to which a weight estimation method according to the present disclosure is applied.

FIG. 12 shows a fail-safe weight estimation and a process of returning to a normal weight estimation, when there are only real driving data of a vehicle with a weight of 14 tones and an inaccurate acceleration offset. Initially, a gradient-converted acceleration offset of 0.017 rad is erroneously applied, but in case an actual gradient-converted acceleration offset is −0.033 rad, a weight estimation algorithm erroneously recognizes that the vehicle is running at about 5% uphill gradient while running on a flatland in fact. Accordingly, as shown in (a) of FIG. 12, the first weight estimator does not show any good convergence, and the second weight estimator shows a misjudgment that the vehicle has a heavier weight than the real weight.

As shown in (b) of FIG. 12, after a normal acceleration offset estimation is performed in about 600 seconds, the first weight estimator and a third weight estimator show convergence on the real weight of 14 tons. The graphs of (c) of FIG. 12 illustrate aₖ,

$${λ}_{k}^{3} ,$$

eₖ from the top. Until about 1,800 seconds have passed, aₖ=1 is maintained because of a difference of estimated weights between the first and second weight estimators. After an error of weight estimation is detected in about 60 seconds, the weight estimation error eₖ is maintained to be 1 and the weight estimation update of the third weight estimator is prohibited until offset correction is newly processed.

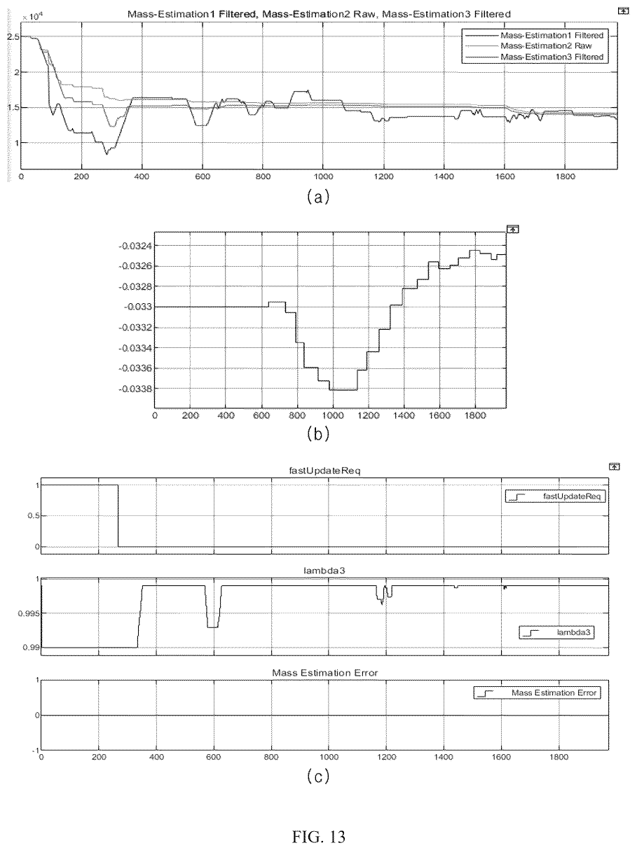

FIG. 13 is a view showing other data of a result to which a weight estimation method according to the present disclosure is applied.

FIG. 13 shows real driving data of a vehicle with a weight of 14 tons and a process of estimating a weight when acceleration offset is normally performed. As shown in (a) of FIG. 13, a first weight estimator converges near on the real weight of 14 tons relatively quickly from an initial assumption of 25 tons but initially shows an unstable behavior with an undershoot of 10 tons or less. On the other hand, a second weight estimator stably converges on 14 tons. However, in case a reference point is 16 tons that enters within a relative error rate of 16%, it takes about 320 seconds. Meanwhile, for a third weight estimator, it takes about 170 seconds to converge on 16 tons. In addition, the third weight estimator has a little fluctuation but does not show such a remarkable undershoot as occurring in the first weight estimator.

(b) of FIG. 13 is a gradient-converted acceleration offset estimation result and shows that the result fluctuates. The graphs of (c) of FIG. 13 illustrate aₖ,

$${λ}_{k}^{3} ,$$

eₖ from the top. aₖ=1 is maintained because of a 120 second condition after initial reset and a condition caused by a difference between first and second estimated weights that occurs subsequently. Next, after both the first weight estimator and the second weight estimator approaches the real weight, RLS3 is stably operated by maintaining high

$${λ}_{k}^{3} .$$

While the methods of the present disclosure described above are represented as a series of operations for clarity of description, it is not intended to limit the order in which the steps are performed. The steps described above may be performed simultaneously or in different order as necessary. In order to implement the method according to the present disclosure, the described steps may further include different or other steps, may include remaining steps except for some of the steps, or may include other additional steps except for some of the steps.

The various examples of the present disclosure do not disclose a list of all possible combinations and are intended to describe representative aspects of the present disclosure. Aspects or features described in the various examples may be applied independently or in combination of two or more.

In addition, various examples of the present disclosure may be implemented in hardware, firmware, software, or a combination thereof. In the case of implementing the present disclosure by hardware, the present disclosure can be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

A method may be performed by an apparatus, of a vehicle, for a weight estimation based on multiple recursive least squares (RLSs) with a forgetting factor. The weight estimation method may comprise: generating first estimated weight information and second estimated weight information based on vehicle data by a first weight estimation and a second weight estimation that use a RLS based on a first forgetting factor and a RLS based on a second forgetting factor having a lower forgetting feature than the first forgetting factor respectively; determining an adaptive third forgetting factor of a third weight estimation that is constructed by a RLS based on the first estimated weight information and the second estimated weight information; and generating ultimate estimated weight information based on the vehicle information by the third weight estimation to which the determined third forgetting factor is applied.

The third forgetting factor may be differently determined according to each section of difference between the first estimated weight information and the second estimated weight information.

The method may further comprise: determining whether or not there is an aggressive update request for the third weight estimation, based on at least one of an operation state of a vehicle, a weight estimation error state related to a divergence state of the first weight estimation or the difference between the first estimated weight information and the second estimated weight information; and applying, in response to the aggressive update request, an aggressive forgetting factor to the third forgetting factor and generating, by an aggressive update of the third weight estimation, the ultimate weight information based on the vehicle data.

The determining of the third forgetting factor based on the first estimated weight information and the second estimated weight information may be performed in response to absence of the aggressive update request.

The aggressive update of the third weight estimation may be performed a predetermined number of times, and further comprising generating, after the aggressive update of the third weight estimation, the ultimate weight information based on the vehicle data by the third weight estimation with the third forgetting factor that is determined based on the first estimated weight information and the second estimated weight information.

The operation state of the vehicle includes a state in which start-up of the vehicle may be turned from off to on.

The weight estimation error state may consider the first weight estimation as a divergence state, when a standard deviation of the first estimated weight information is greater than a deviation reference value because of an acceleration offset caused by a gradient or a replaced component of the vehicle.

The method may further comprise correcting the acceleration offset before the generating of the ultimate weight information by the aggressive update of the third weight estimation, wherein the aggressive update of the third weight estimation is performed after the acceleration offset is corrected.

The determining of whether or not there may be the aggressive update request based on the first estimated weight information and the second estimated weight information may include activating the aggressive update request, when a successive difference between the first estimated weight information and the second estimated weight information, which is generated in time series, is greater than a threshold difference.

The method may further comprise performing an update of the first weight estimation and the second weight estimation while the aggressive update of the third weight estimation is performed.

A vehicle implementing weight estimation based on multiple recursive least squares (RLSs) with a forgetting factor, the vehicle may comprise: a memory configured to store at least one instruction for controlling the vehicle; and a processor configured to execute the at least one instruction stored in the memory, wherein the processor is configured to: generate first estimated weight information and second estimated weight information based on vehicle data by a first weight estimation and a second weight estimation that use a RLS based on a first forgetting factor and a RLS based on a second forgetting factor having a lower forgetting feature than the first forgetting factor respectively, determine an adaptive third forgetting factor of a third weight estimation that is constructed by a RLS based on the first estimated weight information and the second estimated weight information, and generate ultimate estimated weight information based on the vehicle information by the third weight estimation to which the determined third forgetting factor is applied.

The scope of the disclosure includes software or machine-executable commands (e.g., an operating system, an application, firmware, a program, etc.) for enabling operations according to the methods of various examples to be executed on an apparatus or a computer, a non-transitory computer-readable medium having such software or commands stored thereon and executable on the apparatus or the computer.

What is claimed is:

1. A method performed by an apparatus of a vehicle, the method comprising:
determining, based on a first weight estimation being applied to vehicle data, first estimated weight information of the vehicle, wherein the first weight estimation is based on recursive least squares (RLS) associated with a first forgetting factor;
determining, based on a second weight estimation being applied to the vehicle data, second estimated weight information of the vehicle, wherein the second weight estimation is based on RLS associated with a second forgetting factor;
determining, based on the first estimated weight information and the second estimated weight information, a third forgetting factor for RLS of a third weight estimation;
determining, based on the third weight estimation being applied to the vehicle data, third estimated weight information of the vehicle; and
controlling, based on the third estimated weight information, the vehicle.

2. The method of claim 1, wherein the third forgetting factor is differently determined based on a difference between the first estimated weight information and the second estimated weight information, and
wherein the second forgetting factor has a lower forgetting feature than the first forgetting factor.

3. The method of claim 1, further comprising:
determining whether there is an aggressive update request for the third weight estimation, based on at least one of an operation state of the vehicle, a weight estimation error state related to a divergence state of the first weight estimation, or a difference between the first estimated weight information and the second estimated weight information; and
applying, based on the aggressive update request, an aggressive forgetting factor to the third forgetting factor, wherein the aggressive forgetting factor indicates a forgetting feature associated with an increased forgetting rate, and
wherein the determining of the third estimated weight information comprises determining, by an aggressive update of the third weight estimation, the third estimated weight information based on the vehicle data.

4. The method of claim 1, further comprising:
determining whether there is an aggressive update request for the third weight estimation, based on at least one of an operation state of the vehicle, a weight estimation error state related to a divergence state of the first weight estimation, or a difference between the first estimated weight information and the second estimated weight information,
wherein the determining of the third forgetting factor comprises determining the third forgetting factor based on a determination that the aggressive update request is absent, and
wherein a conservative forgetting factor is applied to the third forgetting factor, and wherein the conservative forgetting factor indicates a forgetting feature associated with a decreased forgetting rate.

5. The method of claim 3, wherein the aggressive update of the third weight estimation is performed a predetermined number of times, and
wherein the determining of the third estimated weight information comprises determining the third estimated weight information after the aggressive update of the third weight estimation.

6. The method of claim 3, wherein the operation state of the vehicle comprises a state of transition from an OFF state to an ON state.

7. The method of claim 3, wherein the weight estimation error state comprises the first weight estimation being a divergence state, wherein a standard deviation of the first estimated weight information is greater than a deviation reference value based on an acceleration offset caused by a gradient, on which the vehicle is running, or a replaced component of the vehicle.

8. The method of claim 7, further comprising correcting the acceleration offset before the determining of the third estimated weight information by the aggressive update of the third weight estimation,
wherein the aggressive update of the third weight estimation is performed after the acceleration offset is corrected.

9. The method of claim 3, wherein the determining of whether there is the aggressive update request comprises activating the aggressive update request, based on a successive difference between the first estimated weight information and the second estimated weight information being greater than a threshold difference, and wherein the successive difference is determined in time series.

10. The method of claim 3, further comprising performing an update of the first weight estimation and the second weight estimation while the aggressive update of the third weight estimation is being performed.

11. A vehicle comprising:
memory storing at least one instruction for controlling the vehicle; and
a processor configured to execute the at least one instruction stored in the memory, wherein the at least one instruction is configured to cause, when executed by the processor, the vehicle to:
determine, based on a first weight estimation being applied to vehicle data, first estimated weight information of the vehicle, wherein the first weight estimation is based on recursive least squares (RLS) associated with a first forgetting factor;
determine, based on a second weight estimation being applied to the vehicle data, second estimated weight information of the vehicle, wherein the second weight estimation is based on RLS associated with a second forgetting factor;
determine, based on the first estimated weight information and the second estimated weight information, a third forgetting factor for RLS of a third weight estimation;
determine, based on the third weight estimation being applied to the vehicle data, third estimated weight information of the vehicle; and
control, based on the third estimated weight information, the vehicle.

12. The vehicle of claim 11, wherein the third forgetting factor is differently determined based on a difference between the first estimated weight information and the second estimated weight information, and
wherein the second forgetting factor has a lower forgetting feature than the first forgetting factor.

13. The vehicle of claim 11, wherein the at least one instruction is configured to cause, when executed by the processor, the vehicle to:
determine whether there is an aggressive update request for the third weight estimation, based on at least one of an operation state of the vehicle, a weight estimation error state related to a divergence state of the first weight estimation, or a difference between the first estimated weight information and the second estimated weight information, and
apply, based on the aggressive update request, an aggressive forgetting factor to the third forgetting factor, wherein the aggressive forgetting factor indicates a forgetting feature associated with an increased forgetting rate, and
determine the third estimated weight information by determining, by an aggressive update of the third weight estimation, the third estimated weight information based on the vehicle data.

14. The vehicle of claim 11, wherein the at least one instruction is configured to cause, when executed by the processor, the vehicle to:
determine whether there is an aggressive update request for the third weight estimation, based on at least one of an operation state of the vehicle, a weight estimation error state related to a divergence state of the first weight estimation, or a difference between the first estimated weight information and the second estimated weight information; and
determine the third forgetting factor by determining the third forgetting factor based on a determination that the aggressive update request is absent, and
wherein a conservative forgetting factor is applied to the third forgetting factor, and wherein the conservative forgetting factor indicates a forgetting feature associated with a decreased forgetting rate.

15. The vehicle of claim 13, wherein the aggressive update of the third weight estimation is performed a predetermined number of times, and
wherein the at least one instruction is configured to cause, when executed by the processor, the vehicle to determine the third estimated weight information by determining the third estimated weight information, after the aggressive update of the third weight estimation.

16. The vehicle of claim 13, wherein the operation state of the vehicle comprises a state of transition from an OFF state to an ON state.

17. The vehicle of claim 13, wherein the weight estimation error state comprises the first weight estimation being a divergent state, wherein a standard deviation of the first estimated weight information is greater than a deviation reference value based on an acceleration offset caused by a gradient, on which the vehicle is running, or a replaced component of the vehicle.

18. The vehicle of claim 17, wherein the at least one instruction is configured to cause, when executed by the processor, the vehicle to correct the acceleration offset before determining the third estimated weight information by the aggressive update of the third weight estimation, and
wherein the aggressive update of the third weight estimation is performed after the acceleration offset is corrected.

19. The vehicle of claim 13, wherein the at least one instruction is configured to cause, when executed by the processor, the vehicle to activate the aggressive update request, based on a successive difference between the first estimated weight information and the second estimated weight information being greater than a threshold difference, and wherein the successive difference is determined in time series.

20. The vehicle of claim 13, wherein the at least one instruction is configured to cause, when executed by the processor, the vehicle to perform an update of the first weight estimation and the second weight estimation while the aggressive update of the third weight estimation is being performed.
